(19) United States
(12) Patent Application Publication
(10) Pub. No.: US 2013/0309576 A1
(43) Pub. Date: Nov. 21, 2013

(54) POSITIVE ELECTRODE ACTIVE MATERIAL FOR NONAQUEOUS ELECTROLYTE SECONDARY BATTERY, METHOD FOR PRODUCING THE SAME, POSITIVE ELECTRODE FOR NONAQUEOUS ELECTROLYTE SECONDARY BATTERY USING THE POSITIVE ELECTRODE ACTIVE MATERIAL, AND NONAQUEOUS ELECTROLYTE SECONDARY BATTERY USING THE POSITIVE ELECTRODE

(71) Applicants: Atsushi Ogata, Kobe City (JP); Takeshi Ogasawara, Kobe City (JP)

(72) Inventors: Atsushi Ogata, Kobe City (JP); Takeshi Ogasawara, Kobe City (JP)

(73) Assignee: SANYO ELECTRIC CO., LTD., Moriguchi-shi, Osaka (JP)

(21) Appl. No.: 13/982,389

(22) PCT Filed: Dec. 27, 2011
(86) PCT No.: PCT/JP2011/080286

§ 371 Date: Jul. 29, 2013

(30) Foreign Application Priority Data
Jan. 28, 2011 (JP) 2011-016571

(51) Int. Cl. H01M 4/36

(52) U.S. Cl. CPC H01M 4/366
USPC 429/231.1; 252/182.1

(57) ABSTRACT

An object of the present invention is to provide a positive electrode active material for a nonaqueous electrolyte secondary battery etc. which are capable of suppressing a reaction between a positive electrode and an electrolyte decomposition product moved from a negative electrode and a reaction between the positive electrode and the electrolyte, and which are thereby capable of significantly improving battery characteristics such as continuous charge characteristics (particularly, continuous charge characteristics at a high temperature), cycling characteristics, etc. The positive electrode active material includes a compound containing a rare earth element and fluorine and adhered to a surface of a lithium transition metal composite oxide, the compound having an average particle diameter of 1 nm or less and 100 nm or more.

### TECHNICAL FIELD

The present invention relates to a positive electrode active material for a nonaqueous electrolyte secondary battery, etc.

### BACKGROUND ART

In recent years, reductions in size and weight of mobile information terminals such as a cellular phone, a notebook-size personal computer, PDA, and the like have been rapidly advanced, and batteries used as driving power supplies have been required to have higher capacity. Lithium ion batteries which are charged and discharged by movement of lithium ions between positive and negative electrodes in association with charge and discharge have a high energy density and high capacity, and are thus widely used as driving power supplies for the above-described mobile information terminals.

The mobile information terminals are liable to be further increased in power consumption with enhancement of functions such as a video replay function and a game function, and are strongly demanded to have higher capacity. A method for increasing the capacity of the nonaqueous electrolyte batteries is, for example, a method of increasing the capacity of an active material, a method of increasing the amount of an active material filling per unit volume, or a method of increasing the charge voltage of a battery. However, an increase in charge voltage of a battery increases reactivity between a positive electrode active material and a nonaqueous electrolyte and degrades materials involved in charge and discharge of a battery, thereby not a little adversely affecting battery performance.

In order to solve the above problems, proposals described below have been made.

(1) It is described that a positive electrode active material is coated with a fluoride such as aluminum fluoride, zinc fluoride, lithium fluoride, or the like in an amount of 0.1 to 10% by weight in terms of metal atom relative to the weight of the positive electrode active material (refer to Patent Literature 1 below).

(2) A method for producing a positive electrode including mixing a fluoride at a ratio of 0.3 to 10% by weight relative to the weight of a positive electrode active material is described, in which a composite oxide as a raw material containing lithium, a transition metal, and oxygen is mixed with a fluoride of a rare earth element having an average particle diameter of 20 μm or less, and the resultant mixture is further ground and mixed (refer to Patent Literature 2 below).

### CITATION LIST

### Patent Literature

PTL 1: Japanese Published Unexamined Patent (Transition of PCT Application) No. 2008-536285
PTL 2: Japanese Published Unexamined Patent Application No. 2000-353524

### SUMMARY OF INVENTION

### Technical Problem

The proposal (1) described above uses a method of adding LiCoO₂ as a positive electrode active material to an aqueous solution prepared by dissolving Al(NO₃)₃.9H₂O in distilled water, and then adding an aqueous NH₄F solution. However, in this method, when LiCoO₂ is added to an aqueous solution of Al(NO₃)₃.9H₂O dissolved therein, pH is increased, and thus Al(NO₃)₃.9H₂O is early precipitated as a compound (aluminum hydroxide or the like) other than a fluoride. Therefore, there is a problem that even when ammonium fluoride is then added, aluminum fluoride is not sufficiently produced due to a small amount of Al(NO₃)₃.9H₂O remaining. Also, in the proposal (1), fluorides of rare earth compounds excluding erbium are exemplified, but examples are not described, and the effect achieved by using the fluorides of rare earth compounds is not particularly described.

In addition, as in the proposal (2), a method of mixing a fluoride with a positive electrode active material cannot selectively dispose the fluoride on a surface of the positive electrode active material because the fluoride is mostly located in grain boundaries rather than covers the surface of the positive electrode active material. Therefore, the effect of the fluoride to suppress side reaction between an electrolyte and the positive electrode active material is impaired. Further, since the fluoride and the positive electrode active material are mixed and ground, the positive electrode active material cannot maintain its shape and is finely ground. This results in the problem of difficulty in suppressing a reaction between the positive electrode and, particularly, an electrolyte decomposition product moved from a negative electrode and a reaction between the positive electrode and the electrolyte.

### Solution to Problem

The present invention includes a compound containing a rare earth element and a fluorine element and adhered to a surface of a lithium transition metal composite oxide, the compound having an average particle diameter of 1 nm or more and 100 nm or less.

### Advantageous Effects of Invention

The present invention exhibits the excellent effect of being capable of significantly improving battery characteristics such as charge storage characteristics, cycling characteristics, and the like.

### BRIEF DESCRIPTION OF DRAWINGS

FIG. 1 is a front view of a nonaqueous electrolyte secondary battery according to an embodiment of the present invention.

FIG. 2 is a sectional view taken along arrow line A-A in FIG. 1.

FIG. 3 is a photograph obtained by observing a positive electrode active material of battery A1 with a scanning electron microscope (SEM).

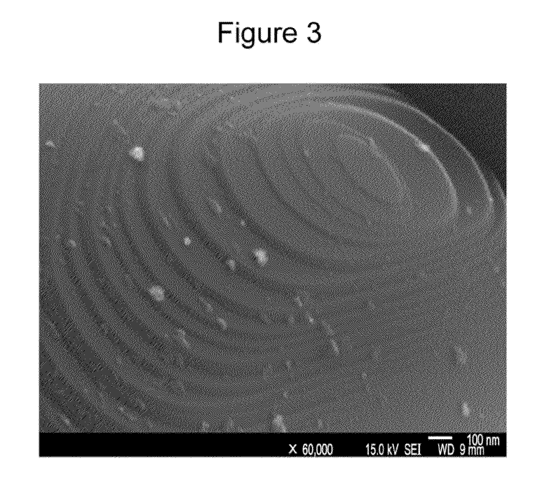

### DESCRIPTION OF EMBODIMENTS

The present invention includes a compound containing rare earth element and a fluorine element and adhered to a surface of a lithium transition metal composite oxide, the compound having an average particle diameter of 1 nm or more and 100 nm or less.

In the above-described configuration, a side reaction between an electrolyte and a lithium transition metal composite oxide can be suppressed (the generation of gas due to the side reaction can also be suppressed), and thus the battery characteristics such as charge storage characteristics (particularly, continuous charge characteristics at a high temperature), cycling characteristics, and the like can be significantly improved.

A reason for this is that when the compound containing a rare earth element and a fluorine element is adhered to a surface of the lithium transition metal composite oxide, a contact area between the lithium transition metal composite oxide and the electrolyte is decreased. As a result, an oxidative decomposition reaction of the electrolyte on the surface of the lithium transition metal composite oxide is suppressed. However, this reason applies to not only the case where the compound containing a rare earth element and a fluorine element is adhered to a surface of the lithium transition metal composite oxide but also the case where a compound containing a fluorine element and an element such as aluminum other than a rare earth element is adhered to a surface of the lithium transition metal composite oxide.

A difference from the case where a compound containing a fluorine element and an element such as aluminum other than a rare earth element is adhered to a surface of the lithium transition metal composite oxide is considered to be due to a reason described below. When a compound containing a fluorine element and an element such as aluminum other than a rare earth element is adhered, the influence of a transition metal (contained in the lithium transition metal composite oxide) which activates a decomposition reaction of the electrolyte cannot be suppressed (that is, the catalytic property of the lithium transition metal composite oxide is not decreased).

On the other hand, when the compound of the present invention is adhered, the influence of the transition metal can be suppressed (that is, the catalytic property of the lithium transition metal composite oxide is decreased).

The average particle diameter of the compound is regulated to 1 nm or more and 100 nm or less for a reason described below. When the compound has an average particle diameter exceeding 100 nm, the compound is excessively large and inhibits movement of lithium over a wide range. In addition, an area of adhering to the lithium transition metal composite oxide is not so increased even by increasing the volume of a compound. Therefore, with the same amount of adhering, the effect of suppressing the side reaction such as decomposition of the electrolyte is less exhibited as the average particle diameter of the compound increases. Although the side reaction is prevented by excessively adding the compound, the excessive addition of the compound causes a decrease in output performance of a battery due to low electron conductivity of the compound.

In contrast, when the compound has an average particle diameter of 100 nm or less, inhibition to lithium movement can be suppressed. In addition, since the side reaction such as decomposition of the electrolyte can be suppressed without excessively adding the compound, the reaction between the electrolyte and the lithium transition metal composite oxide can be more effectively suppressed without causing a decrease in output performance of a battery.

On the other hand, the average particle diameter of the compound is regulated to 1 nm or more for the reason that when the average particle diameter is less than 1 nm, a surface of the lithium transition metal composite oxide is excessively covered with the compound which is little involved directly in charge-discharge reaction, thereby possibly decreasing discharge performance.

In view of the above, the average particle diameter of the compound is more preferably 10 nm or more and 80 nm or less and particularly preferably 10 nm or more and 50 nm or less.

The average particle diameter is a value determined by observation with a scanning electron microscope (SEM).

Examples of the compound containing a rare earth element and a fluorine element include trifluorides such as erbium fluoride, lanthanum fluoride, neodymium fluoride, samarium fluoride, yttrium fluoride, ytterbium fluoride, and the like, cerium fluoride and the like which can be produced as trifluorides and tetrafluoride. These fluorides may be hydrated or may partially contain a hydroxide, an oxyhydroxide, or an oxide.

The compound containing a fluorine element and a rare earth element is preferably erbium fluoride.

This is because erbium can satisfactorily exhibit the above-described operation and effect.

The ratio of the compound containing a fluorine element and a rare earth element to the lithium transition metal composite oxide is preferably 0.01% by mass or more and 0.3% by mass or less in terms of rare earth element. The ratio is more preferably 0.05% by mass or more and 0.2% by mass or less, particularly 0.05% by mass or more and less than 0.1% by mass.

This is because at the ratio of less than 0.01% by mass, the amount of the compound adhering to the surface of the lithium transition metal composite oxide becomes excessively small, thereby failing to achieve a sufficient effect. On the other hand, the ratio exceeding 0.3% by mass causes a decrease in output performance of a battery due to the low electron conductivity of the compound.

The present invention includes adding, while adjusting pH, an aqueous solution prepared by dissolving a compound containing a rare earth element to a suspension containing a water-soluble fluorine-containing compound and a lithium transition metal composite oxide to fix a compound containing a fluorine element and a rare earth element to a surface of the lithium transition metal composite oxide.

According to this method, the compound containing a rare earth element and a fluorine element can be uniformly adhered to a surface of the lithium transition metal composite oxide, and thus a side reaction between an electrolyte and the lithium transition metal composite oxide can be suppressed (the generation of gas due to the side reaction can also be suppressed). Therefore, the battery characteristics such as continuous charge characteristics (particularly, continuous charge characteristics at a high temperature), cycling characteristics, and the like can be significantly improved.

Also, according to this method, when the fluorine-containing compound, the lithium transition metal composite oxide, and the compound containing a rare earth element are mixed together, the lithium transition metal composite oxide is not directly mixed with the compound containing a rare earth element (that is, the lithium transition metal composite oxide is not directly mixed with the compound containing a rare earth element in the presence of the water-soluble fluorine-containing compound). Therefore, it is possible to suppress the occurrence of the problem that a compound (a hydroxide such as erbium hydroxide or the like) other than the compound containing a rare earth element and a fluorine element is early precipitated due to an increase in pH. As a result, the compound containing a rare earth element and a fluorine element is securely produced.

The pH of the suspension is preferably 4 or more and 12 or less. This is because with a pH of less than 4, the lithium transition metal composite oxide may be dissolved. On the other hand, with a pH exceeding 12, impurities such as a rare earth hydroxide and the like may be produced when an aqueous solution prepared by dissolving a compound containing a rare earth element is added. The pH can be adjusted with an acidic or basic aqueous solution.

Examples of the fluorine-containing compound include ammonium fluoride and the like. The amount of the fluorine-containing compound added is preferably regulated to 3 moles to 10 moles per mole of the compound containing a rare earth according to possible valence (that is, an amount of reaction) of the rare earth. This is because when the amount of the compound containing fluoride added is less than the number of moles corresponding to the possible valence of the rare earth, the compound containing a rare earth element and fluorine element may not be sufficiently produced due to an insufficient amount of fluorine. On the other hand, when the amount of the fluorine-containing compound added exceeds 10 moles, the amount of the compound added is excessively large and thus makes waste.

Examples of the compound (rare earth salt) containing a rare earth element include a sulfate, a nitrate, a chloride, an acetate, an oxalate, and the like.

After the compound containing a fluorine element and a rare earth element is adhered to a surface of the lithium transition metal composite oxide, heat treatment is preferably performed at less than 500° C.

After the positive electrode active material is prepared as described above, the positive electrode active material may be heat-treated in an oxidizing atmosphere, a reducing atmosphere, or a reduced-pressure state. In the heat treatment, a heat treatment temperature exceeding 500° C. causes not only decomposition and aggregation of the compound containing a rare earth element and fluorine element adhered to the surface of the lithium transition metal composite oxide but also diffusion of the compound into the lithium transition metal composite oxide with an increase in temperature. This may decrease the effect of suppressing the reaction between the electrolyte and the positive electrode active material. Therefore, the heat treatment is preferably performed at a treatment temperature of less than 500° C.

A positive electrode for a nonaqueous electrolyte secondary battery includes the above-described positive electrode active material for a nonaqueous electrolyte secondary battery, a conductive agent, and a binder. A nonaqueous electrolyte secondary battery includes the positive electrode, a negative electrode, and a nonaqueous electrolyte.

A negative electrode active material contained in the negative electrode preferably contains at least one selected from the group consisting of carbon particles, silicon particles, and silicon alloy particles.

The charge-discharge potential of carbon particles is low and close to the oxidation-reduction potential of metallic lithium, and thus side reaction between carbon and the electrolyte easily occurs on the surfaces of carbon particles during initial charge and discharge.

On the other hand, silicon particles and silicon alloy particles have higher charge-discharge potentials than that of carbon, but the negative electrode active material is cracked due to a change in volume during charge-discharge cycles because of a high degree of expansion and contraction with charge and discharge, thereby producing new surfaces electrochemically active (easily producing reaction with the electrolyte). As a result, side reaction between the electrolyte and silicon particles or the like significantly occurs on the newly formed surfaces during charge-discharge cycles.

Therefore, in the use of any particles, a decomposition product is produced by side reaction between the electrolyte and the negative electrode active material, and the decomposition product is repeatedly moved to the positive electrode. This causes reaction between the decomposition product and the lithium transition metal composite oxide on the surface of the positive electrode, thereby accelerating deterioration in the positive electrode. However, when the compound containing a rare earth element and a fluorine element is adhered to the surface of the lithium transition metal composite oxide, the occurrence of such a reaction can be suppressed.

### (Other Matters)

(1) The lithium transition metal composite oxide in the positive electrode active material of the present invention contains transition metals such as cobalt, nickel, manganese, and the like. Specific examples thereof include lithium cobalt oxide, lithium Ni—Co—Mn composite oxide, lithium Ni—Mn—Al composite oxide, lithium Ni—Co—Al composite oxide, lithium Co—Mn composite oxide, and transition metal oxo acid salts containing iron, manganese, or the like (represented by LiMPO₄, Li₂MSiO₄, or LiMBO₃ wherein M is selected from Fe, Mn, Co, and Ni). These may be used alone or as a mixture.

(2) The lithium transition metal composite oxide may contain a substance of Al, Mg, Ti, Zr, or the like dissolved as solid solution or located at grain boundaries. Besides the compound containing a rare earth element and a fluorine element, a compound of Al, Mg, Ti, Zr, or the like may be adhered to the surface of the lithium transition metal composite oxide. This is because even when such a compound is adhered, contact between the electrolyte and the positive electrode active material can be suppressed.

(3) The lithium nickel-cobalt-manganese oxide having a known composition having a molar ratio of nickel, cobalt, and manganese of 1:1:1, 5:3:2, 5:2:3, 6:2:2, 7:1:2, 7:2:1, or the like can be used. In order to increase the positive electrode capacity, the ratios of nickel and cobalt are particularly preferably higher than that of manganese.

(4) A solvent of a nonaqueous electrolyte used in the present invention is not limited, and a solvent generally used for nonaqueous electrolyte secondary batteries can be used. Examples thereof include cyclic carbonates such as ethylene carbonate, propylene carbonate, butylene carbonate, vinylene carbonate, and the like; linear carbonates such as dimethyl carbonate, methylethyl carbonate, diethyl carbonate, and the like; ester-containing compounds such as methyl acetate, ethyl acetate, propyl acetate, methyl propionate, ethyl propionate, γ-butyrolactone, and the like; sulfone group-containing compounds such as propanesultone and the like; ether-containing compounds such as 1,2-dimethoxyethane, 1,2-diethoxyethane, tetrahydrofuran, 1,2-dioxane, 1,4-dioxane, 2-methyltetrahydrofuran, and the like; nitrile-containing compounds such as butyronitrile, valeronitrile, n-heptanenitrile, succinonitrile, glutarnitrile, adiponitrile, pimelonitrile, 1,2,3-propanetricarbonitrile, 1,3,5-pentanetricarbonitrile, and the like; amide-containing compounds such as dimethylformamide and the like. In particular, these solvents each partially substituted by F for H can be preferably used. These solvents can be used alone or in combination of two or more, and in particular, a solvent containing a combination of a cyclic carbonate and a linear carbonate, and a solvent further containing a small amount of nitrile-containing compound or ether-containing compound in combination with a cyclic carbonate and a linear carbonate are preferred.

On the other hand, a solute which has been used can be used as a solute of a nonaqueous electrolyte, and examples thereof include LiPF₆, LiBF₄, LiN(SO₂CF₃)₂, LiN(SO₂C₂F₅)₂, LiPF₆₋ₓ(CₙF₂ₙ₋₁)_{X} (wherein 1<x<6, N=1 or 2), and the like. These may be used alone or as a mixture of two or more. The concentration of the solute is not particularly limited but is preferably 0.8 to 1.8 mol per liter of the electrolyte.

(5) A negative electrode which has been used can be used as the negative electrode in the present invention. In particular, a lithium-absorbable and desorbable carbon material, a metal capable of alloying with lithium, or an alloy compound containing the metal can be used.

Examples of the carbon material which can be used include graphites such as natural graphite, non-graphitizable carbon, artificial graphite, and the like; cokes, and the like. An alloy compound containing at least one metal capable of alloying with lithium can be used. In particular, silicon and tin are preferred as an element capable of alloying with lithium, and silicon oxide, tin oxide, and the like, which contain oxygen bonded to the elements, can also be used. Also, a mixture of the carbon material and a silicon or tin compound can be used.

Besides the above-described materials, a material having a lower energy density but a higher charge-discharge potential versus metallic lithium, such as lithium titanate, than that of carbon materials can be used as a negative electrode material.

(6) A layer composed of an inorganic filler, which has been used, can be formed at an interface between the positive electrode and a separator or an interface between the negative electrode and a separator. As the filler, titanium, aluminum, silicon, magnesium, and the like, which have been used, can be used alone, used as an oxide or phosphoric acid compound containing two or more of these elements, or used after being surface-treated with a hydroxide or the like.

Usable examples of a method for forming the filler layer include a forming method of directly applying a filler-containing slurry to the positive electrode, the negative electrode, or the separator, a method of bonding a sheet made of the filler to the positive electrode, the negative electrode, or the separator, and the like.

(7) A separator which has been used can be used as the separator in the present invention. Specifically, not only a separator composed of polyethylene but also a separator including a polypropylene layer formed on a surface of a polyethylene layer and a polyethylene separator including a resin such as an aramid resin or the like applied to a surface thereof may be used.

### EXAMPLES

A positive electrode active material for a nonaqueous electrolyte secondary battery, a positive electrode, and a battery according to the present invention are described below. The positive electrode active material for a nonaqueous electrolyte secondary battery, the positive electrode, and the battery according to the present invention are not limited to those described in examples below, and appropriate modification can be made without changing the gist of the present invention.

### First Example

In the first example, the effect obtained by using silicon as a negative electrode active material was examined.

### Example 1

### Preparation of Positive Electrode

### (1) Preparation of Positive Electrode Active Material

First, 1000 g of particles of lithium cobalt oxide containing 1.0 mol % each of Mg and Al dissolved as solid solution and 0.04 mol % of Zr was prepared, and the particles were added to 3.0 L of pure water and stirred to prepare a suspension in which the lithium cobalt oxide was dispersed. Next, an aqueous solution prepared by dissolving 1 g of ammonium fluoride in 100 mL of pure water was added to the suspension. Next, a solution prepared by dissolving 1.81 g (0.068% by mass in terms of erbium element) of erbium nitrate pentahydrate in 200 mL of pure water was added to the suspension. The molar ratio between erbium and fluorine was adjusted to 1:6.7. In addition, a 10 mass % aqueous solution of nitric acid or a 10 mass % aqueous solution of sodium hydroxide was appropriately added for constantly adjusting the suspension containing lithium cobalt oxide and ammonium fluoride to pH 7.

After the addition of the erbium nitrate pentahydrate solution was completed, the resultant mixture was filtered by suction and the residue was further washed with water. The resultant powder was dried at 120° C. to yield a positive electrode active material in which a compound (may be simply referred to as an “erbium compound” hereinafter) containing fluorine and erbium was adhered to a surface of the lithium cobalt oxide. Then, the resultant powder of the positive electrode active material was heat-treated in air at 300° C. for 5 hours.

Observation of the resultant positive electrode active material with a scanning electron microscope (SEM) confirmed that the erbium compound is uniformly dispersed and adhered to the surface of the lithium cobalt oxide, and the erbium compound has an average particle diameter of 1 nm or more and 100 nm or less. In addition, ICP measurement of the amount of the compound adhered showed a value of 0.068% by mass in terms of erbium element relative to the lithium cobalt oxide.

### (2) Preparation of Positive Electrode

The powder of the positive electrode active material, a carbon black (acetylene black) powder (average particle diameter: 40 nm) as a positive electrode conductive agent, and polyvinylidene fluoride (PVdF) as a positive electrode binder (binder) were kneaded at a mass ratio of 95:2.5:2.5 in a NMP solution to prepare a positive-electrode mixture slurry. Finally, the positive electrode mixture slurry was coated to both surfaces of a positive-electrode current collector composed of an aluminum foil, dried, and then rolled with a rolling mill to produce a positive electrode including positive electrode mixture layers formed on both surfaces of the positive-electrode current collector. The packing density of the positive electrode was 3.7 g/cc.

### [Preparation of Negative Electrode]

### (1) Preparation of Negative Electrode Active Material

First, a polycrystalline silicon block was formed by a heat reduction method. Specifically, a silicon core installed in a metal reaction furnace (reduction furnace) was heated to 800° C. by electric heating, and a gas mixture containing a vapor of purified high-purity monosilane (SiH₄) gas and purified hydrogen was flowed into the furnace to precipitate polycrystalline silicon on the surface of the silicon core, producing a thick bar-shaped polycrystalline silicon block.

Next, the polycrystalline silicon block was ground and classified to form polycrystalline silicon particles (negative electrode active material particles) with a purity of 99%. The polycrystalline silicon particles had a crystallite size of 32 nm and a median diameter of 10 μm. The crystallite size was calculated according to the Scherrer equation using a half-width of a (111) peak of silicon in powder X-ray diffraction. The median diameter was defined as a diameter at 50% of accumulated volume in grain size distribution measurement by a laser diffraction method.

### (2) Preparation of Negative-Electrode Mixture Slurry

The negative electrode active material powder, a graphite powder serving as a negative electrode conductive agent and having an average particle diameter of 3.5 μm, and a precursor varnish (solvent: NMP, concentration: 47% by mass in terms of polyimide resin after polymerization and imidization by heat treatment) of a thermoplastic polyimide resin serving as a negative electrode binder and having a molecular structure represented by Chem. 1 below (n is an integer of 1 or more) and a glass transition temperature of 300° C. were mixed with NMP used as a dispersion medium so that the mass ratio between the negative electrode active material powder, the negative electrode conductive agent powder, and the polyimide resin after imidization was 89.5:3.7:6.8, preparing a negative-electrode mixture slurry.

The precursor varnish of the polyimide resin can be produced from 3,3′,4,4′-benzophenonetetracarboxylic acid diethyl ester represented by Chem. 2, 3, or 4 below, and m-phenylenediamine represented by Chem. 5 below. 3,3′,4,4′-benzophenonetetracarboxylic acid diethyl ester represented by Chem. 2, 3, or 4 below can be produced by reacting 2 equivalents of ethanol with 3,3′,4,4′-benzophenonetetracarboxylic acid dianhydride represented by Chem. 6 below in the presence of NMP.

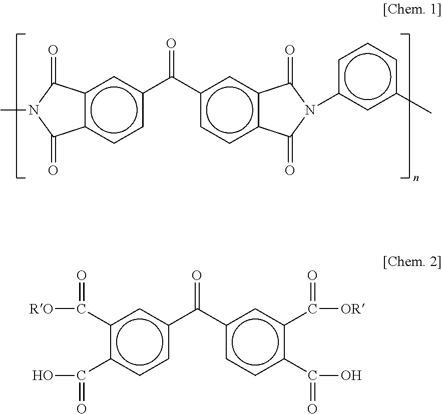

wherein R′ is an ethyl group.

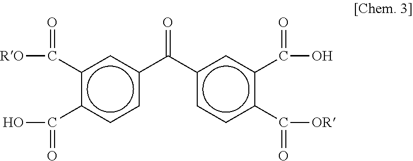

wherein R′ is an ethyl group.

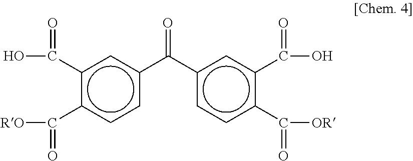

wherein R′ is an ethyl group.

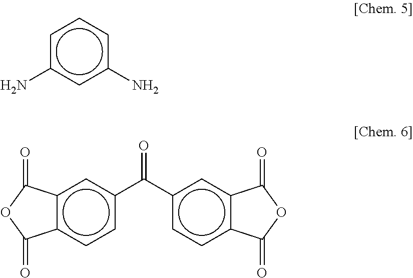

### (3) Preparation of Negative Electrode

A copper alloy foil having a thickness of 18 μm (C7025 alloy foil having a composition containing 96.2% by mass of Cu, 3% by mass of Ni, 0.65% by mass of Si, and 0.15% by mass of Mg) was used as a negative-electrode current collector, in which the both surfaces were roughened to have a surface roughness Ra (JIS B 0601-1994) of 0.25 μm and a mean peak spacing S (JIS B 0601-1994) of 1.0 μm. The negative-electrode mixture slurry was applied to both surfaces of the negative-electrode current collector in air at 25° C., dried in air at 120° C., and then rolled in air at 25° C. The resultant product was cut into a rectangular shape having a length of 380 mm and a width of 52 mm an then heat-treated in an argon atmosphere at 400° C. for 10 hours to form a negative electrode including negative electrode active material layers formed on the surfaces of the negative-electrode current collector. The negative electrode had a packing density of 1.6 g/cc, and a nickel plate was attached as a negative-electrode current collector tab to an end of the negative electrode.

### [Preparation of Nonaqueous Electrolyte]

Lithium hexafluorophosphate (LiPF₆) was dissolved at 1 mol/l in a solvent prepared by mixing fluoroethylene carbonate (FEC) and methylethyl carbonate (MEC) at a volume ratio of 20:80, and then 0.4% by mass of carbon dioxide gas was dissolved in the resulting solution to prepare a nonaqueous electrolyte.

### [Formation of Battery]

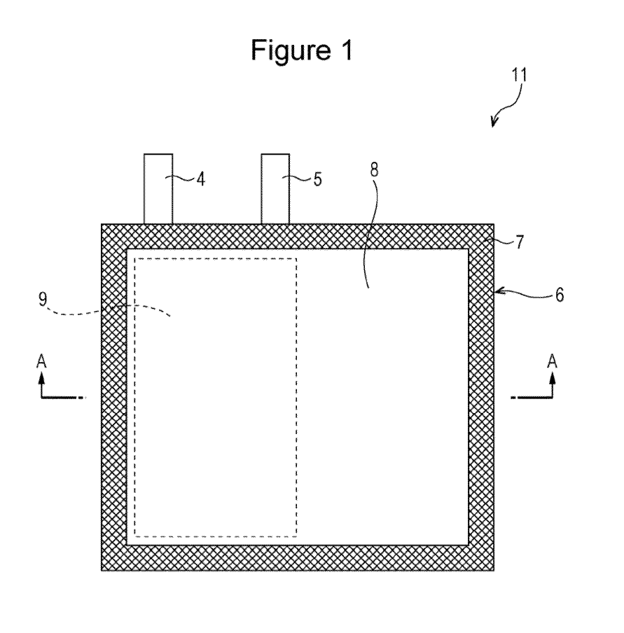

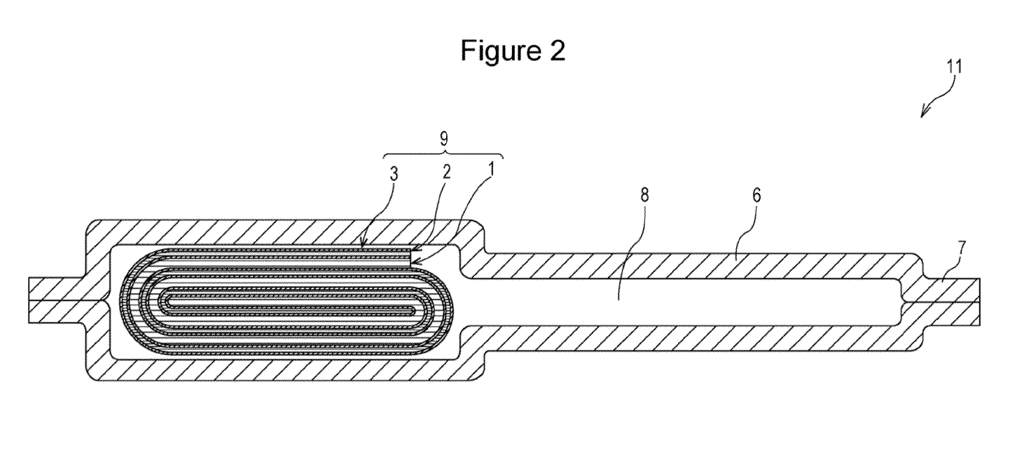

A lead terminal was attached to each of the positive and negative electrodes, and the positive and negative electrodes with a separator disposed therebetween were spirally coiled. Then, a core was removed to form a spirally coiled electrode body, and the electrode body was further pressed to form a flat electrode body. Next, the flat electrode body and the nonaqueous electrolyte were disposed in an outer case made of two aluminum laminates in a CO₂ atmosphere at 1 atm and 25° C. and then sealed to form a flat nonaqueous electrolyte secondary battery 11 having a structure shown in FIGS. 1 and 2. The secondary battery 11 had a size of thickness 3.6 mm×width 70 mm×height 62 mm, and when the secondary battery was charged to 4.35 V and discharged to 2.75 V, the discharge capacity was 850 mAh.

As shown in FIGS. 1 and 2, the nonaqueous electrolyte secondary battery 11 has a specific structure in which a positive electrode 1 and a negative electrode 2 are disposed to face each other with a separator 3 therebetween, and a flat electrode body 9 including the positive and negative electrodes 1 and 2 and the separator 3 is impregnated with the nonaqueous electrolyte. The positive and negative electrodes 1 and 2 are connected to a positive-electrode current collector tab 4 and a negative-electrode current collector tab 5, respectively, thereby forming a structure chargeable and dischargeable as a secondary battery. The electrode body 9 is disposed in a receiving space of an aluminum laminate outer case 6 including an opening 7 with a heat-sealed periphery. In the figures, reference numeral 8 denotes a space chamber for minimizing the influence of gas generated by decomposition of the electrolyte or the like on charge and discharge.

The thus-formed battery is referred to as “battery A1” hereinafter.

### Example 2

A positive electrode active material was prepared by the same method as in Example 1 except that in preparing the positive electrode active material, a solution prepared by dissolving 1.77 g of lanthanum nitrate hexahydrate in 200 mL of pure water was used as a solution to be added to a suspension in place of the solution prepared by dissolving erbium nitrate pentahydrate in 200 mL of pure water. In the thus-prepared positive electrode active material, it is considered that a compound containing lanthanum and fluorine elements (may be referred to as a “lanthanum compound” hereinafter) is adhered to a surface of lithium cobalt oxide, and the ratio of the lanthanum compound to lithium cobalt oxide was 0.057% by mass in terms of lanthanum element (specified to be equimolecular to that in Example 1 in terms of metal element).

The thus-formed battery is referred to as “battery A2” hereinafter.

### Comparative Example 1

A battery was formed by the same method as in Example 1 except that a positive electrode active material not containing an erbium compound adhered to the lithium cobalt oxide (that is, the positive electrode active material composed of only the lithium cobalt oxide) and not subjected to heat treatment was used.

The thus-formed battery is referred to as “battery Z1” hereinafter.

### Comparative Example 2

A battery was formed by the same method as in Example 1 except that in preparing a positive electrode active material, 200 mL of pure water was added in place of the solution prepared by dissolving erbium nitrate pentahydrate.

The thus-formed battery is referred to as “battery Z2” hereinafter.

### Comparative Example 3

A positive electrode active material was prepared by the same method as in Example 1 except that in preparing the positive electrode active material, 200 mL of a solution prepared by dissolving 1.53 g of aluminum nitrate nonahydrate was added in place of erbium nitrate pentahydrate. In the thus-prepared positive electrode active material, it is considered that a compound containing aluminum and fluorine elements (may be referred to as an “aluminum compound” hereinafter) is adhered to a surface of lithium cobalt oxide, and the ratio of the aluminum compound to lithium cobalt oxide was 0.011% by mass in terms of aluminum element (specified to be equimolecular to that in Example 1 in terms of metal element).

The thus-formed battery is referred to as “battery Z3” hereinafter.

### Comparative Example 4

A battery was formed by the same method as in Comparative Example 1 except that an erbium fluoride powder having an average particle diameter of 500 nm was mixed with a lithium cobalt oxide powder. The ratio of erbium fluoride to lithium cobalt oxide was 0.068% by mass in terms of erbium element.

The thus-formed battery is referred to as “battery Z4” hereinafter.

### (Experiment)

The cycling characteristics and high-temperature continuous charge characteristics of each of the batteries A1, A2, and Z1 to Z4 were examined by charge and discharge under conditions described below. The results are shown in Table 1.

### [Charge-Discharge Conditions for Cycling Characteristic Test]

Charge Condition

The condition was that constant-current charge was performed with a current of 1.0 It (850 mA) until a battery voltage was 4.35 V, and then charge was performed with a constant voltage until a current was 0.05 It (42.5 mA).

Discharge Condition

The condition was that constant-current discharge was performed with a current of 1.0 It (850 mA) until a battery voltage was 2.75 V.

Resting

A rest interval between the charge and discharge was 10 minutes.

The cycling characteristics were evaluated by repeating in order the charge, resting, discharge, and resting to determine a battery lifetime when the discharge capacity in a predetermined cycle was 80% of the discharge capacity in the first cycle.

The temperature of the cycling characteristic test was 25° C.±5° C.

### [Charge-Discharge Conditions for Continuous Charge Characteristic Test]

Charge-discharge was performed once under the same charge-discharge conditions as those for the cycling characteristic test to measure discharge capacity (discharge capacity before the continuous charge test). Next, each of the batteries was allowed to stand at 60° C. for 1 hour in a constant-temperature oven and then charged with a constant current of 1.0 It (850 mA) to a battery voltage of 4.35 V in the environment of 60° C. and further charged with a constant voltage of 4.35 V. When the total charge time at 60° C. reached 48 hours, the battery was removed from the constant-temperature oven of 60° C. Then, the battery was cooled to room temperature, and then discharge capacity (first discharge capacity after the continuous charge test) was measured. A capacity residual rate was calculated from the discharge capacities before and after the continuous charge test using equation (1) below.

Capacity residual rate(%)=(first discharge capacity after continuous charge test/discharge capacity before continuous charge test)×100 (1)

TABLE 1

| | | | Compound on surface of | | | |
|---|---|---|---|---|---|---|
| | Negative | | lithium cobalt oxide | | | |
| | electrode | | | Element | Number | Capacity |
| Type of | active | Solvent of | | contained in | of | residual |
| battery | material | electrolyte | State | compound | cycles | rate (%) |
| Battery A1 | Silicon | FEC + | Adhered | Erbium + | 250 | 84 |
| | | MEC | | fluorine | | |
| Battery A2 | | | Adhered | Lanthanum + | 225 | 81 |
| | | | | fluorine | | |
| Battery Z1 | | | — | No | 110 | 76 |
| Battery Z2 | | | — (only | No | 110 | 76 |
| | | | ammonium | | | |
| | | | fluoride | | | |
| | | | added) | | | |
| Battery Z3 | | | Adhered | Aluminum + | 180 | 77 |
| | | | | fluorine | | |
| Battery Z4 | | | Added | Erbium + | 120 | 76 |
| | | | | fluorine | | |

Table 1 indicates that the batteries A1 and A2 are excellent in cycling characteristics (number of cycles) and high-temperature continuous charge characteristics (capacity residual rate) as compared with the batteries Z1 to Z4.

The high-temperature continuous charge characteristics mainly represent deterioration of the positive electrode with a side reaction between the positive electrode and the electrolyte and the degree of the occurrence of gas due to the side reaction. However, as described above, the batteries A1, A2, and Z1 to Z4 are each provided with a space chamber for storing gas in order to decrease the influence of the gas generated by the side reaction. Therefore, the deterioration of the positive electrode with the side reaction between the positive electrode and the electrolyte can be mainly examined.

In view of the above, considering the results shown in Table 1, the battery Z3 containing the aluminum compound adhered to the surface of lithium cobalt oxide exhibits a slightly higher capacity residual rate than the battery Z1 not containing a compound adhered to a surface of lithium cobalt oxide and the battery Z4 formed by adding erbium fluoride (the compound being not adhered to a surface of lithium cobalt oxide). On the other hand, the battery A1 and the battery A2 each containing a rare earth compound, such as an erbium compound or lanthanum compound, adhered to a surface of lithium cobalt oxide exhibit significantly higher capacity residual rates than not only the batteries Z1 and Z4 but also the battery Z3.

These results are considered to be due to the reason that in the batteries A1 and A2, deterioration of the positive electrode with the side reaction between the positive electrode and the electrolyte can be suppressed during the continuous charge test. Although, in the batteries A1, A2, and Z3, a compound is adhered to a surface of lithium cobalt oxide, the capacity residual rates of the batteries A1 and A2 are higher than that of the battery Z3 for the following conceivable reason. As in the battery Z3, when an aluminum compound is adhered to a surface of lithium cobalt oxide, the influence of transition metals contained in the lithium transition metal composite oxide which activate decomposition reaction of the electrolyte cannot be suppressed (that is, the catalytic property of the lithium transition metal composite oxide is not decreased). In contrast, as in the batteries A1 and A2, when a rare earth compound such as an erbium compound or a lanthanum compound is adhered to a surface of lithium cobalt oxide, the influence of transition metals can be suppressed (that is, the catalytic property of the lithium transition metal composite oxide is decreased). In comparison between the battery A1 and the battery A2, when an erbium compound is adhered, a more excellent effect is achieved.

In addition to deterioration of the positive electrode, a factor influencing the cycling characteristics is that the decomposition product produced by side reaction between the negative electrode and the electrolyte is moved to the positive electrode and accelerates the deterioration of the positive electrode, thereby decreasing the discharge capacity. In particular, when silicon is used as the negative electrode active material, the negative electrode active material is cracked with a change in volume during charge-discharge cycles because of a high degree of expansion and contraction with charge and discharge, thereby producing new surfaces electrochemically active (easily producing side reaction with the electrolyte). As a result, side reaction between the electrolyte and the negative electrode active material more significantly occurs. In addition, the decomposition product due to the side reaction is repeatedly moved to the positive electrode and thus reacts with the lithium transition metal composite oxide on the surface of the positive electrode, thereby accelerating the deterioration of the positive electrode.

In view of the above, considering the results shown in Table 1, the battery Z3 exhibits excellent cycling characteristics as compared with the battery Z1 and the battery Z4, but the battery A1 and the battery A2 exhibit significantly excellent cycling characteristics as compared with not only the batteries Z1 and Z4 but also the battery Z3. This is due to the reason that in the batteries Z1, Z3, and Z4, the influence of the decomposition product produced from the negative electrode cannot be suppressed or not satisfactorily suppressed. In contrast, in the batteries A1 and A2, the influence of the decomposition product produced from the negative electrode can be satisfactorily suppressed.

When as in the battery Z2, a battery is formed by adding a fluorine compound, but not adding a compound containing an erbium element, the cycling characteristics and high-temperature continuous charge characteristics are completely the same as the battery Z1. Therefore, it is considered that in the battery Z2, a compound which can suppress deterioration of the positive electrode and the influence of the decomposition product produced from the negative electrode is not produced on a surface of lithium cobalt oxide in the step of preparing the positive electrode active material.

As described above, it can be confirmed that the cycling characteristics and high-temperature continuous charge characteristics can be improved by adhering even a small amount of a rare earth compound of erbium or lanthanum, particularly an erbium compound, to a surface of lithium cobalt oxide.

### Second Example

In the second example, it was examined whether or not the same effect was achieved even by using a carbon material (graphite) as the negative electrode active material, and whether or not the same effect was achieved even by using a rare earth element, other than erbium and lanthanum, to be contained in the compound adhered to the surface of the positive electrode active material.

### Example 1

This example was the same as Example 1 of the above-described first example except that formation of a negative electrode, preparation of a nonaqueous electrolyte, and formation of a battery were conduced as described below. That is, the configuration of the positive electrode was completely the same as in Example 1 of the above-described first example.

The thus-formed battery is referred to as “battery B1” hereinafter.

### [Formation of Negative Electrode]

Graphite used as a negative electrode active material, SBR (styrene-butadiene rubber) used as a binder, and CMC (carboxymethyl cellulose) used as a thickener were weighed at a mass ratio of 98:1:1, and then kneaded in an aqueous solution to prepare a negative electrode active material slurry. The negative-electrode active material slurry was applied in a predetermine amount to both surfaces of a copper foil used as a negative-electrode current collector, further dried, and then rolled so that the packing density was 1.7 g/cc to form a negative electrode.

### [Preparation of Nonaqueous Electrolyte]

Lithium hexafluorophosphate (LiPF₆) was dissolved at 1 mol/l in a solvent prepared by mixing ethylene carbonate (EC) and methylethyl carbonate (MEC) at a volume ratio of 20:80 to prepare a nonaqueous electrolyte.

### [Formation of Battery]

A lead terminal was attached to each of the positive and negative electrodes, and the positive and negative electrodes with a separator disposed therebetween were spirally coiled. Then, a core was removed to form a spirally coiled electrode body, and the electrode body was further pressed to form a flat electrode body. Next, the flat electrode body and the nonaqueous electrolyte were disposed in an outer case made of two aluminum laminates in an argon atmosphere at 1 atm and 25° C. and then sealed to form a flat nonaqueous electrolyte secondary battery 11 having a structure shown in FIGS. 1 and 2. The secondary battery 11 had a size of thickness 3.6 mm×width 70 mm×height 62 mm, and when the secondary battery was charged to 4.40 V and discharged to 2.75 V, the discharge capacity was 750 mAh.

### Example 2

A battery was formed by the same method as in Example 1 of the second example except that in preparing the positive electrode active material, 1.56 g of yttrium nitrate hexahydrate was used in place of 1.81 g of erbium nitrate pentahydrate. Observation of the resultant positive electrode active material with a scanning electron microscope (SEM) confirmed that a compound containing yttrium and fluorine is uniformly dispersed and adhered to a surface of lithium cobalt oxide, and the compound has an average particle diameter of 1 nm or more and 100 nm or less. In addition, ICP measurement of the amount of the compound adhered showed a value of 0.036% by mass in terms of yttrium element relative to the lithium cobalt oxide (specified to be equimolecular to that in Example 1 of the second example in terms of metal element).

The thus-formed battery is referred to as “battery B2” hereinafter.

### Example 3

A battery was formed by the same method as in Example 1 of the second example except that in preparing the positive electrode active material, 1.77 g of lanthanum nitrate hexahydrate was used in place of 1.81 g of erbium nitrate pentahydrate. Observation of the resultant positive electrode active material with a scanning electron microscope (SEM) confirmed that a compound containing lanthanum and fluorine is uniformly dispersed and adhered to a surface of lithium cobalt oxide, and the compound has an average particle diameter of 1 nm or more and 100 nm or less. In addition, ICP measurement of the amount of the compound adhered showed a value of 0.057% by mass in terms of lanthanum element relative to the lithium cobalt oxide (specified to be equimolecular to that in Example 1 of the second example in terms of metal element).

The thus-formed battery is referred to as “battery B3” hereinafter.

### Example 4

A battery was formed by the same method as in Example 1 of the second example except that in preparing the positive electrode active material, 1.79 g of neodymium nitrate hexahydrate was used in place of 1.81 g of erbium nitrate pentahydrate. Observation of the resultant positive electrode active material with a scanning electron microscope (SEM) confirmed that a compound containing neodymium and fluorine is uniformly dispersed and adhered to a surface of lithium cobalt oxide, and the compound has an average particle diameter of 1 nm or more and 100 nm or less. In addition, ICP measurement of the amount of the compound adhered showed a value of 0.059% by mass in terms of neodymium element relative to the lithium cobalt oxide (specified to be equimolecular to that in Example 1 of the second example in terms of metal element).

The thus-formed battery is referred to as “battery B4” hereinafter.

### Example 5

A battery was formed by the same method as in Example 1 of the second example except that in preparing the positive electrode active material, 1.82 g of samarium nitrate hexahydrate was used in place of 1.81 g of erbium nitrate pentahydrate. Observation of the resultant positive electrode active material with a scanning electron microscope (SEM) confirmed that a compound containing samarium and fluorine is uniformly dispersed and adhered to a surface of lithium cobalt oxide, and the compound has an average particle diameter of 1 nm or more and 100 nm or less. In addition, ICP measurement of the amount of the compound adhered showed a value of 0.061% by mass in terms of samarium element relative to the lithium cobalt oxide (specified to be equimolecular to that in Example 1 of the second example in terms of metal element).

The thus-formed battery is referred to as “battery B5” hereinafter.

### Example 6

A battery was formed by the same method as in Example 1 of the second example except that in preparing the positive electrode active material, 1.69 g of ytterbium nitrate trihydrate was used in place of 1.81 g of erbium nitrate pentahydrate. Observation of the resultant positive electrode active material with a scanning electron microscope (SEM) confirmed that a compound containing ytterbium and fluorine is uniformly dispersed and adhered to a surface of lithium cobalt oxide, and the compound has an average particle diameter of 1 nm or more and 100 nm or less. In addition, ICP measurement of the amount of the compound adhered showed a value of 0.071% by mass in terms of ytterbium element relative to the lithium cobalt oxide (specified to be equimolecular to that in Example 1 of the second example in terms of metal element).

The thus-formed battery is referred to as “battery B6” hereinafter.

### Comparative Example

A battery was formed by the same method as in Example 1 of the second example except that a positive electrode active material not containing an erbium compound adhered to lithium cobalt oxide (that is, the positive electrode composed of only lithium cobalt oxide) and not subjected to heat treatment was used.

The thus-formed battery is referred to as “battery Y” hereinafter.

### (Experiment)

The cycling characteristics and high-temperature continuous charge characteristics of the batteries B1 to B6 and Y were examined. The results are shown in Table 2.

The charge-discharge conditions for examining the cycling characteristics were the same as in the experiment in the first example except that 1.0 It was 750 mA, and the charge voltage was 4.40 V instead of 4.35 V. Also, the charge-discharge conditions for examining the continuous charge characteristics were the same as in the experiment in the first example except that 1.0 It was 750 mA, the total charge time at 60° C. was 65 hours instead of 48 hours, and the charge voltage was 4.40 V instead of 4.35 V.

TABLE 2

| | | | Compound on surface of | | | |
|---|---|---|---|---|---|---|
| | Negative | | lithium cobalt oxide | | | |
| | electrode | | | Element | Number | Capacity |
| Type of | active | Solvent of | | contained in | of | residual |
| battery | material | electrolyte | State | compound | cycles | rate (%) |
| Battery B1 | Graphite | EC + | Adhered | Erbium + | 440 | 84 |
| | | MEC | | fluorine | | |
| Battery B2 | | | Adhered | Yttrium + | 370 | 81 |
| | | | | fluorine | | |
| Battery B3 | | | Adhered | Lanthanum + | 260 | 81 |
| | | | | fluorine | | |
| Battery B4 | | | Adhered | Neodymium + | 190 | 82 |
| | | | | fluoride | | |
| Battery B5 | | | Adhered | Samarium + | 420 | 82 |
| | | | | fluorine | | |
| Battery B6 | | | Adhered | Ytterbium + | 400 | 81 |
| | | | | fluorine | | |
| Battery Y | | | — | — | 110 | 72 |

Table 2 indicates that even when graphite (carbon material) is used as the negative electrode active material, excellent cycling characteristics and continuous charge storage characteristics can be achieved by adhering a rare earth compound composed of fluorine and a rare earth element, such as erbium, yttrium, lanthanum, neodymium, samarium, or ytterbium, to a surface of lithium cobalt oxide.

A factor of this is considered to be due to the following reasons.

(1) When a compound containing a rare earth element and a fluorine element is adhered to a surface of lithium cobalt oxide, an area of contact between the lithium transition metal composite oxide and the electrolyte is decreased. Therefore, it is possible to suppress the occurrence of oxidative decomposition reaction of the electrolyte on the surface of the lithium transition metal composite oxide.

(2) Even when graphite is used as the negative electrode active material, side reaction between the electrolyte and the negative electrode active material occurs on the surface of the negative electrode active material, producing a decomposition product. The decomposition product is moved to the positive electrode, and thus when a compound containing a rare earth element and a fluorine element is not adhered to a surface of lithium cobalt oxide, the decomposition product reacts with the lithium transition metal composite oxide on the surface of the positive electrode, thereby accelerating deterioration of the positive electrode. However, when a compound containing a rare earth element and a fluorine element is adhered to a surface of lithium cobalt oxide, reaction between the decomposition product and the lithium transition metal composite oxide on the surface of the positive electrode can be suppressed.

### Third Example

In the third example, differences in effect with different types of negative electrode active materials were examined.

### Example 1

A battery was formed by the same method as in Example 1 of the first example except that the discharge capacity of the battery was 750 mAh.

The thus-formed battery is referred to as “battery C1” hereinafter.

### Comparative Example 1

A battery was formed by the same method as in Example 1 of the third example except that a positive electrode active material not containing an erbium compound adhered to lithium cobalt oxide (that is, the positive electrode composed of only lithium cobalt oxide) and not subjected to heat treatment was used.

The thus-formed battery is referred to as “battery X1” hereinafter.

### Example 2

A battery was formed by the same method as in Example 1 of the second example except that when the discharge capacity of the battery was 750 mAh, and an electrolyte described below was used. The electrolyte used was prepared by dissolving lithium hexafluorophosphate (LiPF₆) at 1 mol/litter in a solvent prepared by mixing fluoroethylene carbonate (FEC) and methylethyl carbonate (MEC) at a volume ratio of 20:80, and then dissolving 0.4 mass % of carbon dioxide gas in the resultant solution.

The thus-formed battery is referred to as “battery C2” hereinafter.

### Comparative Example 2

A battery was formed by the same method as in Example 2 of the third example except that a positive electrode active material not containing an erbium compound adhered to lithium cobalt oxide (that is, the positive electrode composed of only lithium cobalt oxide) and not subjected to heat treatment was used.

The thus-formed battery is referred to as “battery X2” hereinafter.

### (Experiment)

The cycling characteristics (capacity of each of the batteries after the passage of 200 cycles) of the batteries C1, C2, X1, and X2 were examined. The results are shown in Table 3. The charge-discharge conditions for examining the cycling characteristics were the same as in the experiment of the first example except that 1.0 It was 750 mA. A value of the battery C1 was indicated by an index relative to 100 of the capacity of the battery X1 after 200 cycles, and a value of the battery C2 was indicated by an index relative to 100 of the capacity of the battery X2 after 200 cycles.

TABLE 3

| | | | Compound on surface of | | |
|---|---|---|---|---|---|
| | Negative | | lithium cobalt oxide | | |
| | electrode | Solvent | | Element | Cycling |
| Type of | active | of elec- | | contained | charac- |
| battery | material | trolyte | State | in compound | teristic |
| Battery C1 | Silicon | FEC + | Adhered | Erbium + | 250 |
| | | MEC | | fluorine | |
| Battery X1 | | | No | — | 100 |
| Battery C2 | Graphite | | Adhered | Erbium + | 105 |
| | | | | fluorine | |
| Battery X2 | | | No | — | 100 |

Table 3 indicates that when graphite (carbon material) or silicon is used as the negative electrode active material, the cycling characteristics are improved by adhering the compound composed of a rare earth element, such as erbium, and a fluorine element to the surface of lithium cobalt oxide. In particular, it is found that when silicon is used as the negative electrode active material, the effect of improving cycling characteristics is significant.

This is because, as described above, silicon easily produces new surfaces by a phenomenon such as cracks due to a large change by expansion and contraction during charge-discharge cycles. Therefore, decomposition reaction of the electrolyte easily occurs on the surface of the negative electrode active material, and thus the amount of the decomposition product produced by the reaction and moved to the positive electrode is significantly increased. Therefore, unless the compound composed of a rare earth element and a fluorine element is adhered to the surface of lithium cobalt oxide, the positive electrode greatly deteriorates. In contrast, when graphite is used as the negative electrode active material, decomposition reaction of the electrolyte less occurs on the surface of the negative electrode active material as compared with the use of silicon as the negative electrode material, and thus the amount of the decomposition product moved to the positive electrode is not so large. Therefore, even when the compound composed of a rare earth element and a fluorine element is not adhered to the surface of lithium cobalt oxide, deterioration in the positive electrode is small.

### INDUSTRIAL APPLICABILITY

The present invention can be expected for development of driving power supplies for mobile information terminals, for example, cellular phones, notebook-size personal computers, PDAs, and the like, and driving power supplies for high output, for example, HEVs and electric tools.

### REFERENCE SIGNS LIST

1: positive electrode
2: negative electrode
3: separator
4: positive-electrode current collector tab
5: negative-electrode current collector tab
6: aluminum laminate outer case
8: space chamber
11: nonaqueous electrode secondary battery

1-9. (canceled)

10. A positive electrode active material for a nonaqueous electrolyte secondary battery, the positive electrode active material comprising a compound containing a fluorine element and a rare earth element and adhered to a surface a lithium transition metal composite oxide, wherein the compound has an average particle diameter of 1 nm or more and 100 nm or less.

11. The positive electrode active material for a nonaqueous secondary battery according to claim 10, wherein the compound containing a fluorine element and a rare earth element is erbium fluoride.

12. The positive electrode active material for a nonaqueous secondary battery according to claim 10, wherein a ratio of the compound containing a fluorine element and a rare earth element to the lithium transition metal composite oxide is 0.01% by mass or more and 0.3% by mass or less in terms of rare earth element.

13. The positive electrode active material for a nonaqueous secondary battery according to claim 11, wherein a ratio of the compound containing a fluorine element and a rare earth element to the lithium transition metal composite oxide is 0.01% by mass or more and 0.3% by mass or less in terms of rare earth element.

14. A method for producing a positive electrode active material for a nonaqueous electrolyte secondary battery, the method comprising adding, while adjusting pH, an aqueous solution prepared by dissolving a compound containing a rare earth element to a suspension containing a water-soluble fluorine-containing compound and a lithium transition metal composite oxide.

15. The method for producing a positive electrode active material for a nonaqueous electrolyte secondary battery according to claim 14, wherein a compound containing a fluorine element and a rare earth element is adhered to a surface of the lithium transition metal composite oxide, and then heat treatment is performed at less than 500° C.

16. A positive electrode for a nonaqueous electrolyte secondary battery comprising the positive electrode active material for a nonaqueous electrolyte secondary battery according to claim 10, a conductive agent, and a binder.

17. A positive electrode for a nonaqueous electrolyte secondary battery comprising the positive electrode active material for a nonaqueous electrolyte secondary battery according to claim 11, a conductive agent, and a binder.

18. A positive electrode for a nonaqueous electrolyte secondary battery comprising the positive electrode active material for a nonaqueous electrolyte secondary battery according to claim 12, a conductive agent, and a binder.

19. A positive electrode for a nonaqueous electrolyte secondary battery comprising the positive electrode active material for a nonaqueous electrolyte secondary battery according to claim 13, a conductive agent, and a binder.

20. A nonaqueous electrolyte secondary battery comprising the positive electrode according to claim 16, a negative electrode, and a nonaqueous electrolyte, wherein a negative electrode active material contained in the negative electrode contains at least one selected from the group consisting of carbon particles, silicon particles, and silicon alloy particles.

21. A nonaqueous electrolyte secondary battery comprising the positive electrode according to claim 17, a negative electrode, and a nonaqueous electrolyte, wherein a negative electrode active material contained in the negative electrode contains at least one selected from the group consisting of carbon particles, silicon particles, and silicon alloy particles.

22. A nonaqueous electrolyte secondary battery comprising the positive electrode according to claim 18, a negative electrode, and a nonaqueous electrolyte, wherein a negative electrode active material contained in the negative electrode contains at least one selected from the group consisting of carbon particles, silicon particles, and silicon alloy particles.

23. A nonaqueous electrolyte secondary battery comprising the positive electrode according to claim 19, a negative electrode, and a nonaqueous electrolyte, wherein a negative electrode active material contained in the negative electrode contains at least one selected from the group consisting of carbon particles, silicon particles, and silicon alloy particles.

24. The nonaqueous electrolyte secondary battery according to claim 20, wherein a compound containing silicon particles or silicon alloy particles is used as the negative electrode active material.

25. The nonaqueous electrolyte secondary battery according to claim 21, wherein a compound containing silicon particles or silicon alloy particles is used as the negative electrode active material.

26. The nonaqueous electrolyte secondary battery according to claim 22, wherein a compound containing silicon particles or silicon alloy particles is used as the negative electrode active material.

27. The nonaqueous electrolyte secondary battery according to claim 23, wherein a compound containing silicon particles or silicon alloy particles is used as the negative electrode active material.
